(19) United States
(12) Patent Application Publication
(10) Pub. No.: US 2007/0174214 A1
(43) Pub. Date: Jul. 26, 2007

(54) Integrated fraud management systems and methods

(76) Inventors: Robert Welsh, Apple Valley, MN (US); Robert L. Evans, Scottsdale, AZ (US); Traci Larson, Hastings, MN (US); Terry Gedemer, Champlin, MN (US); Brenda Carlson, Oakdale, MN (US); James L. LeTourneau, St. Paul, MN (US)

Correspondence Address: MICHAEL BEST & FRIEDRICH, LLP, 100 E WISCONSIN AVENUE, Suite 3300, MILWAUKEE, WI, 53202, US

(21) Appl. No.: 11/402,287

(22) Filed: Apr. 11, 2006

Related U.S. Application Data
(60) Provisional application No. 60/670,902, filed on Apr. 13, 2005.

(51) Int. Cl. G06F 12/14; G06F 12/16; G07B 17/02

(52) U.S. Cl. 705/405

(57) ABSTRACT

Methods and systems for managing a plurality of alerts. One system can include a fraud management module operative to receive a plurality of alerts from a plurality of fraud detection tools and to process the plurality of alerts, each of the plurality of alerts indicating potentially fraudulent activity.

### RELATED APPLICATIONS

The present application claims priority to U.S. Provisional Patent Application Ser. No. 60/670,902 of the same title, filed on Apr. 13, 2005, the entire contents of which are herein incorporated by reference.

### BACKGROUND OF THE INVENTION

In response to increased fraud, financial institutions have implemented numerous independent tools in order to help address specific fraud challenges associated with various payment types. While helping to combat the problem, the multitude of fraud detection tools has also introduced additional challenges for financial institutions in the form of staffing and process inefficiency associated with administering the tools.

In addition, individuals performing fraudulent behavior in one market seldom limit themselves to one market, and often hit the easiest target to make money. Therefore, multiple fraud detection/tracking tools may exist in multiple markets or industries. For example, independent tools may exist to detect and track brokerage fraud, telecom fraud, loan fraud, automatic teller machine (“ATM”) fraud, transaction fraud, identification verification fraud, insurance fraud, new financial account fraud, identity theft, electronic benefits transfer fraud, check fraud, credit card fraud, financial account takeover fraud, and retail fraud. Without combining the functionality of these cross-industry tools, however, individuals known to perform fraudulent behavior in one market can more easily perform fraudulent behavior in another market without experiencing immediate detection and/or apprehension.

### SUMMARY OF THE INVENTION

Therefore, some embodiments of the invention provide an integrated fraud system. The system integrates potential fraud information from a plurality of fraud detection/management tools, such as a new account decisioning system, into a consolidated data source. The system can also integrate other related information, such as customer demographics and transaction history, with the potential fraud information. The system then prioritizes and/or categorizes alerts generated by the plurality of fraud detection/management tools into appropriate work queues. In addition, the system immediately processes obtained alerts that can be handled automatically without human intervention. The system can also provide a research and decisioning user interface that presents alerts, combined with other related information (e.g., customer demographic and transaction history, images of checks, etc.) in order to enable a research analyst to assess and decision an alert. The system can also perform automated actions in order to process a particular alert, such as generating correspondence, generating follow-up reminders, performing account disposition, performing alert escalation, creating an investigation case, and/or creating a collection process. The system can also provide case management by providing a facility to investigate confirmed fraud or compliance related cases, including generating one or more types of suspicious activity reports (“SARs”) used for compliance reporting, documenting recoveries, and investigating processes and related people and companies. In addition, the system can provide analytical tools for mining data integrated by the system in order to improve fraud detection and prevention.

Additional embodiments provide a system for managing a plurality of alerts, wherein each of the plurality of alerts indicating potentially fraudulent activity. The system can include a fraud management module operative to receive a plurality of alerts from a plurality of fraud detection tools and to process the plurality of alerts.

Another embodiment provides a method of managing a plurality of alerts, wherein each of the plurality of alerts indicating potentially fraudulent activity. The method can include receiving a plurality of alerts from a plurality of fraud detection tools and processing the plurality of alerts.

Embodiments also provide a method of managing a plurality of alerts, wherein each of the plurality of alerts indicating potentially fraudulent activity. The method can include receiving a plurality of alerts from a plurality of fraud detection tools and displaying at least one of the plurality of alerts to an analyst.

### BRIEF DESCRIPTION OF THE DRAWINGS

FIG. 1 is a schematic illustration of prior art fraud management components.

FIG. 2 is a schematic illustration of an integrated fraud management system according to one embodiment of the invention.

FIG. 3 is another schematic illustration of an integrated fraud management system according to one embodiment of the invention.

FIG. 4 is a schematic illustration of a fraud management process performed by the fraud management system of FIG. 3.

FIGS. 5-7 illustrate a research and decisioning user interface according to one embodiment of the invention.

FIG. 8 is a schematic illustration of an alert process performed by an integrated fraud management system according to one embodiment of the invention.

FIG. 9 is another schematic illustration of an integrated fraud management system according to one embodiment of the invention.

FIG. 10 is still another schematic illustration of an integrated fraud management system according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

In addition, it should be understood that embodiments of the invention include both hardware and electronic components or modules that, for purposes of discussion, can be illustrated and described as if the majority of the components were implemented solely in hardware. However, one of ordinary skill in the art, and based on a reading of this detailed description, would recognize that, in at least one embodiment, the electronic based aspects of the invention can be implemented in software. As such, it should be noted that a plurality of hardware and software based devices, as well as a plurality of different structural components can be utilized to implement the invention. Furthermore, and as described in subsequent paragraphs, the specific configurations illustrated in the drawings are intended to exemplify embodiments of the invention and that other alternative configurations are possible.

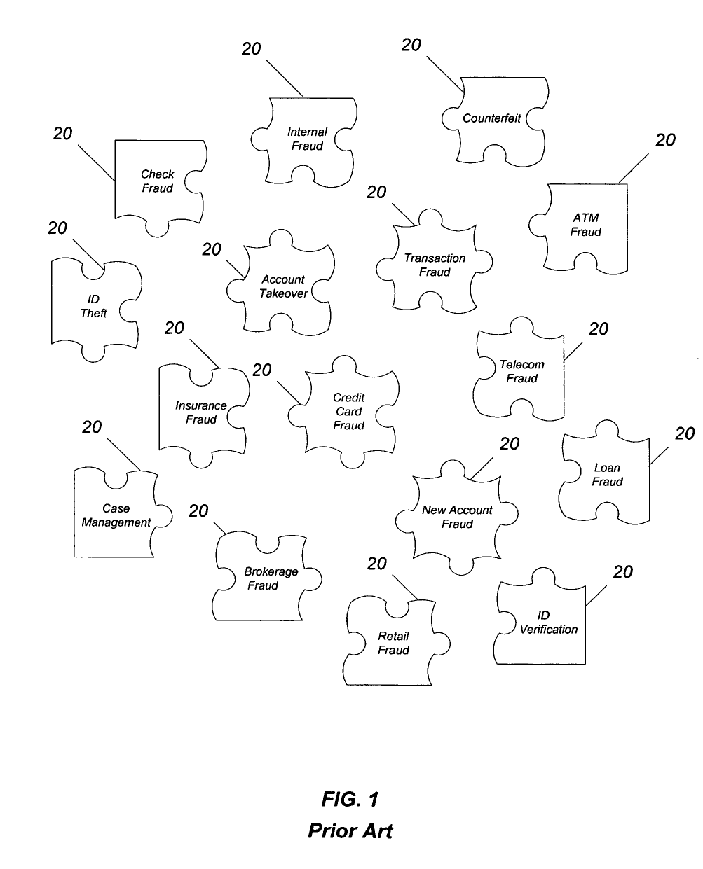

FIG. 1 is a schematic illustration of prior art fraud detection/management tools and components 20. As shown in FIG. 1, there are multiple types of fraud in different markets, and for each type of fraud, an independent tool 20 may exist that addresses that type of fraud in a particular market. For example, independent tools 20 may exist to detect and track brokerage fraud, telecom fraud, loan fraud, automatic teller machine (“ATM”) fraud, transaction fraud, identification verification fraud, insurance fraud, new financial account fraud, identity theft, electronic benefit transfer fraud, check fraud, credit card fraud, financial account takeover fraud, and retail fraud. As described above, however, without combining the functionality of these cross-industry tools 20, individuals known to perform fraudulent behavior in one market can more easily perform fraudulent behavior in another market without experiencing immediate detection and/or apprehension.

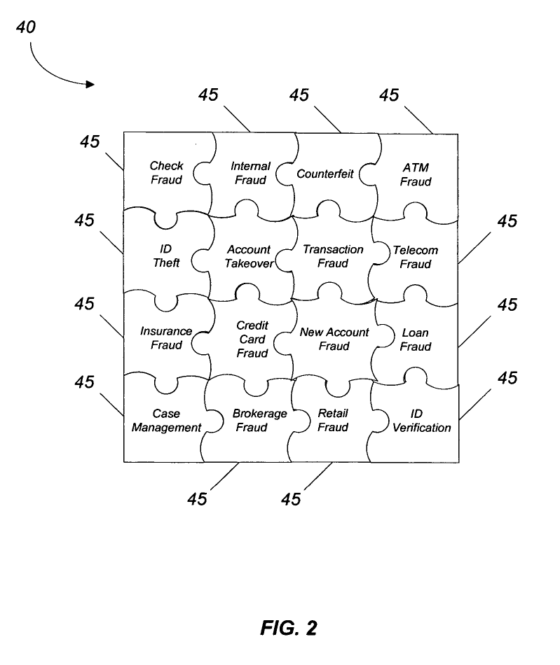

FIG. 2 is a schematic illustration of an integrated fraud management system 40 according to one embodiment of the invention. The integrated fraud management system 40 communicates with one or more independent fraud detection/management tools 45, such as those illustrated in FIG. 1, and consolidates and shares fraud information and fraud detection/management tools across multiple types of fraud in multiple types of markets. The integrated fraud management system 40 can be used in a variety of markets for various types of transactions, such as retail transactions, credit card transactions, telecommunication transactions, insurance transactions, brokerage transactions, electronic benefits transfer transactions, etc., in order to provide an integrated fraud detection and prevention solution that combines fraud detection/management tools 45 associated with various transactions in various markets.

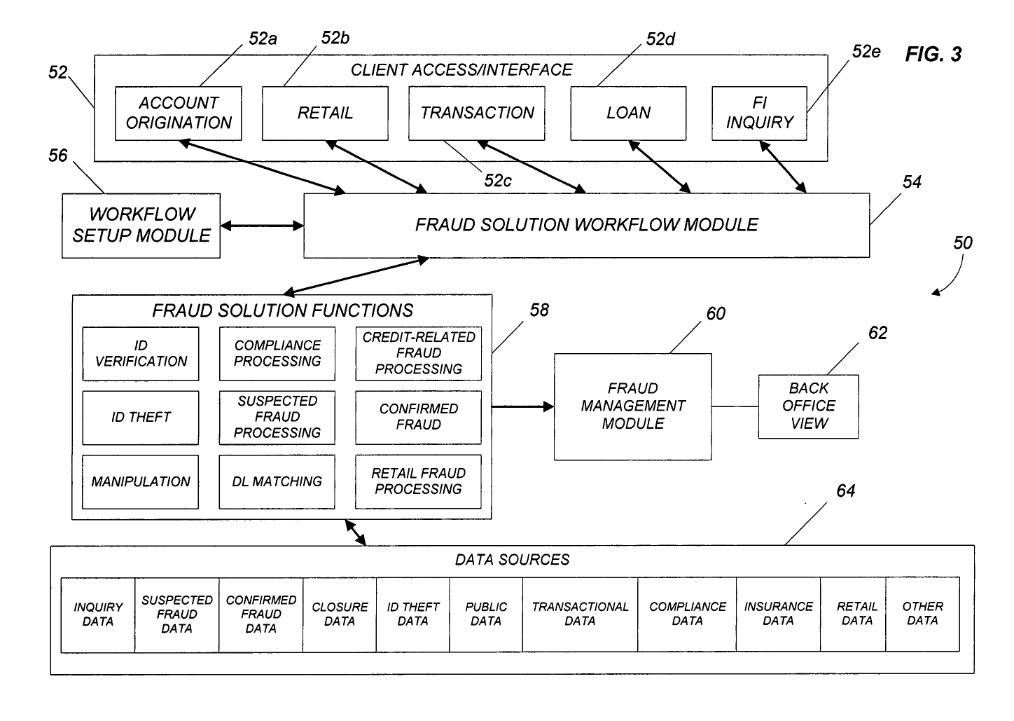

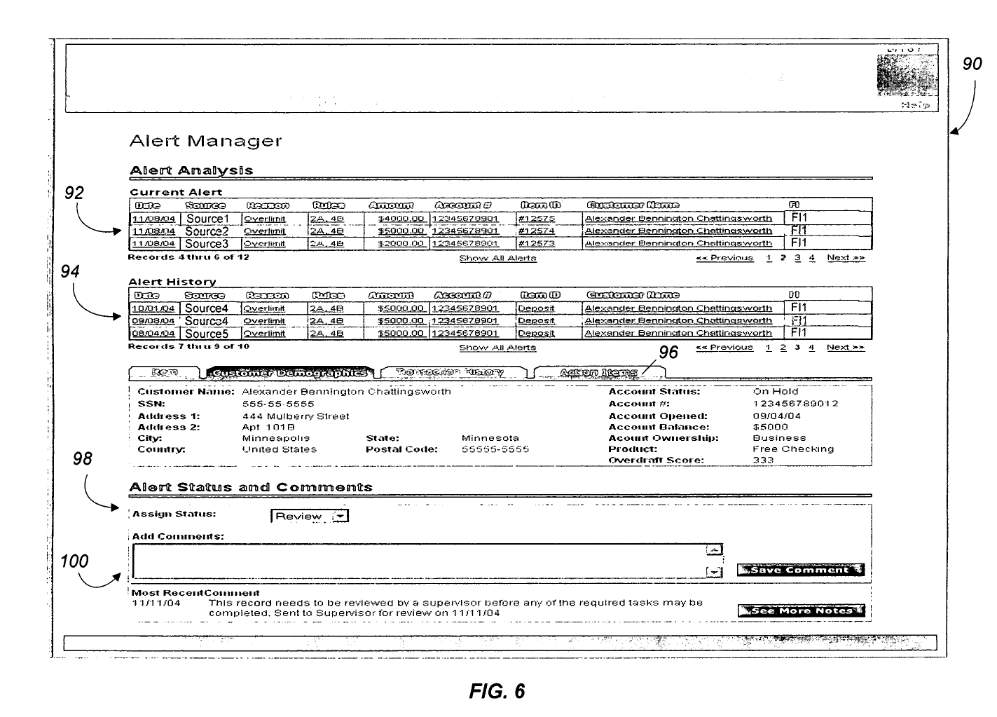

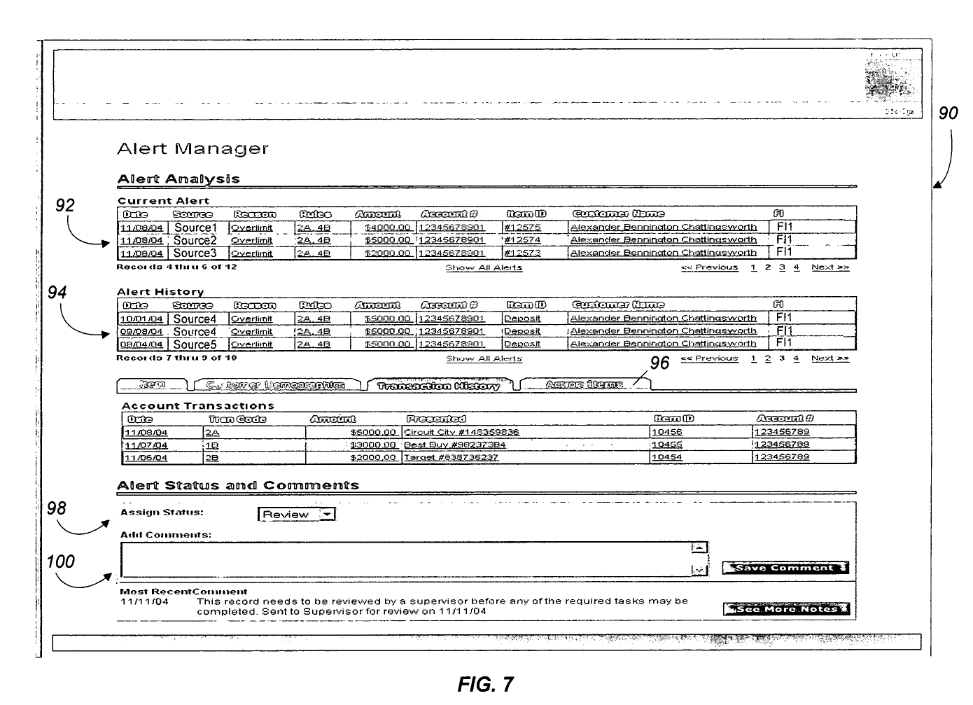

In some embodiments, as described in further detail below with respect to FIGS. 3-10, embodiments of the invention provide an integrated fraud management system configured to provide fraud management for an entire life cycle of a fraudulent transaction. For example, the integrated fraud management system can manage a fraudulent or potentially fraudulent transaction from the time of the initial inquiry or authorization request regarding the transaction through the researching and investing of the inquiry and any related alerts. In addition, the integrated fraud management system can analyze the processing performed in relation to the transaction and can implement process improvements. The integrated fraud management system is applicable across multiple market spaces and can incorporate real-time inquiry and/or batch requests from multiple markets and sources (e.g., national and international) in order to identify potential negative responses and/or alerts. The integrated fraud management system can also provide research tools that allow clients to review internal and/or external alerts associated with a particular customer and/or an account in a consolidated view. The integrated fraud management system also allows clients to determine steps required for processing an alert, which the integrated fraud management system then carries out, even to case investigation, if required. Once it is determined that an alert identifies true fraud and/or fraud-related loss is realized, the integrated fraud management system can also provide analytic and reporting tools in order to improve alert processing performed by the integrated fraud management system and, therefore, determine new fraud trends.

The integrated fraud management system incorporates sources of potential fraud data through an enterprise (i.e., from multiple sources) and automates data acquisition wherever possible. In addition, the integrated fraud management system can provide an integrated research and decisioning user interface in order to manage potential fraud and compliance alerts or events automatically handled by the integrated fraud management system and/or alerts or events requiring manual intervention by a client. Furthermore, the integrated fraud management system can provide comprehensive case management functionality in order to manage investigative processes, compliance reporting, and recovery management. The integrated fraud management system can also provide linking functionality to link data from multiple data sources in order to supplement research and investigations. The integrated fraud management system can further provide methods for analyzing fraud and compliance data in order to identify fraud trends that can be turned into new actions taken by the integrated fraud management system in order to attempt to reduce fraud and improve compliance effectiveness. In addition, the integrated fraud management system can also incorporate global outsourcing services for the performance of one or more back office research and investigative tasks as well as analytical functions.

FIG. 3 is another schematic illustration of an integrated fraud management system 50 according to one embodiment of the invention. As shown in FIG. 3, the integrated fraud management system 50 includes a client access/interface 52, a fraud solution workflow module 54, a workflow setup module 56, one or more fraud solution functions 58, a fraud management module 60, a back office view 62 of the fraud management module 60, and one or more data sources 64. It should be understood that components of the integrated fraud management system 50 can be provided in client-hosted mode or application service provider (“ASP”) mode. In ASP mode, a service provider provides a client (e.g., an individual and/or an enterprise) access to one or more components of the integrated fraud management system 50 over a network connection, such as over the Internet. In ASP mode, a component of the integrated fraud management system 50 accessed by the client is executed by the service provider. In some embodiments, the client can access a component of the integrated fraud management system 50 in ASP mode through a function call or a system call. The component of the integrated fraud management system 50 obtains the system call, processes the call, and returns a response to the client application or system from where the system call originated.

In client-hosted mode, a component of the integrated fraud management system 50 accessed by the client is located and executed on a computing device operated by the client. Depending on the intended use of the integrated fraud management system 50 by a client, components of the integrated fraud management system 50 can be provided in client-hosted mode or ASP mode.

It should be understood that the integrated fraud management system 50 can also include additional components and that the functionality of the components of the integrated management system 50 can be combined and distributed in various configurations other than those illustrated and described.

The client access/interface 52 includes one or more sources that generate system inquiries. As shown in FIG. 3, inquiries can be generated by an account origination processing system 52a, a retail transaction processing system 52b, an electronic transaction processing system 52c, a loan processing system 52d, and/or other financial institution systems 52e. The integrated fraud management system 50 can accept inquiries from each of the inquiry sources in real-time or in batch mode. The integrated fraud management system 50 can also return inquiry responses to the inquiry sources in real-time or in batch mode.

Upon receiving an inquiry (e.g., a request for authorization), the fraud solution workflow module 54 identifies processing steps needed to satisfy or respond to the inquiry. The fraud solution workflow module 54 can also coordinate the acquisition of the needed services and the order or flow of applying the needed services. In some embodiments, the processing steps and services identified and applied by the fraud solution workflow module 54 to a particular inquiry can be configured using the workflow setup module 56. It should be understood that the functionality of the fraud solution workflow module 54 can be distributed amongst the inquiry sources of the client access/interface 52. For example, rather than submitting each inquiry to the fraud solution workflow module 54, an inquiry source of the client access/interface 52 can directly submit each inquiry to one or more fraud solution functions 58.

In some embodiments, the fraud solution workflow module 54 identifies one or more fraud solution functions 58 to be applied to an inquiry in order to service and respond to an inquiry. The fraud solution functions 58 can include functions used to identify potential fraudulent behavior and/or prevent fraudulent behavior from taking place. For example, the fraud solution functions 52 can perform identity verification that identifies compliance and data mismatches, validation processing of social security numbers and/or driver's license numbers, compliance screening of Office of Foreign Assets Control (“OFAC”) databases, searching of identity theft victim databases and/or other financial databases, monitoring of suspected fraud data and configured fraud data, manipulation processing, e.g. detection of purposeful attempts to avoid identification by manipulating or altering identification numbers such as Social Security numbers, retail processing such as monitoring heavy hitters, and credit card fraud processing.

The fraud solution functions 58 can use data from a variety of data sources 64 in order to support fraud solution functions from multiple markets and/or industries. For example, the fraud solution functions 58 can obtain inquiry data from one or more industries (e.g., financial institutions, insurance providers, telecom providers, brokerage firms, etc.); suspected fraud data represented by multiple industries; confirmed fraud data reported by multiple industries (e.g., Fair Credit Reporting Act (“FCRA”) implications); closure information reported by financial institutions; identify theft data of victims and consumers who want financial information changes monitored; public data, such as warm addresses, social security group numbers, driver license states, bankruptcy information, etc.; transactional data from electronic financial transaction and/or automatic teller machine industries; telecom data needed to provide a fraud solution to the insurance industry; retail reported fraud information (e.g., Shared Check Authorization Network (“SCAN”)); compliance data, such as data provided by the OFAC and/or data provided by the Financial Crimes Enforcement Network (“FinCen”) and related reporting; insurance data needed to provide a fraud solution for the insurance industry; and other data that may be needed to provide an integrated fraud solution to multiple industries and types of transactions.

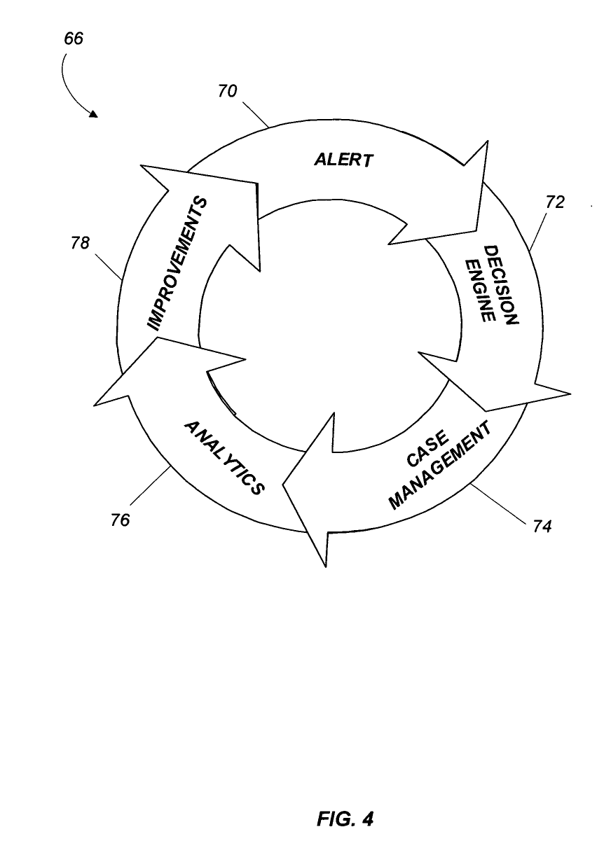

Alerts and/or events generated by fraud solution functions 58 are sent to the fraud management module 60. As described below with respect to FIG. 4, the fraud management module 60 reviews the alerts and processes the alerts. In some embodiments, the fraud management module 60 uses a decision engine or another processing tool to prioritize and/or categorize the alerts and/or events. The fraud management module 60 can also present alerts and any other needed or helpful data to a research analyst for manual review and/or decisioning. In some embodiments, depending on the decisions determined by the research analyst (or decisions made automatically by the fraud management module 60), the fraud management module 60 (or other components of the integrated fraud management system 50) also performs automated actions based on the decision. For example, the fraud management module 60 can provide letter generation, follow-up reminders, account disposition, escalation, investigation case creating, and/or collection process creation.

As also described below with respect to FIG. 4, the integrated fraud management system 50 also provides case management functionality that facilitates the investigation of confirmed fraud and/or compliance related cases. For example, the integrated fraud management system 50 can provide investigation reporting tools to assist investigators and investigations management, can generate multiple types of SARs for compliance reporting, can document recoveries, and can investigate processes and related people and companies. The integrated fraud management system 50 can also provide analytical tools that can be used to mine data processed by the integrated fraud management system 50 in order to improve alert processing and fraud detection. In addition, the integrated fraud management system 50 can log response events. The logged data can be used as a data source for one or more fraud solution functions 58 and/or analytic tools.

FIG. 4 is a schematic illustration of a fraud management process 66 performed by the fraud management module 60. The fraud management process 66 includes a collect alerts step 70 (Alert), a decision analysis step 72 (Decision Engine), a case management step 74 (Case Management), a linking/analytics step 76 (Analytics), and an improvement step 78 (Improvements). During the collect alerts step 70, the fraud management module 60 obtains one or more alerts from one or more fraud solution functions 58. The alerts identify potential fraudulent items, suspicious activity, and/or compliance actions. In some embodiments, the alerts can include one or more scores generated by a fraud solution function 58 that indicates likelihood that fraudulent behavior is taking place. During the collect alerts step 70, the fraud management module 60 can also receive exception items from the back office view 62. In addition, the alerts can include customer reports and other incident reports. Furthermore, the fraud management module 60 can obtain alerts generated or obtained from one or more internal and/or external fraud reporting systems. Additional processing systems can also generate alerts that include loss events, such as the returning or bouncing of a check, and can provide the alerts to the integrated fraud management system 50.

After collecting one or more alerts, the fraud management module 60 consolidates the alerts (exceptions, reports, etc.) during the decision analysis step 72. During the decision analysis step 72, the fraud management module 60 can also obtain information related to an alert in order to make a decision as to whether the alert and corresponding information suggests fraudulent or non-compliant behavior. In some embodiments, the fraud management module 60 includes an information integrator that moves information to and from the fraud management module 60 and integrates fraud-related information into a consolidated data source. The information integrator provides one or more mechanisms for accessing multiple data sources and systems in order to import and/or export data to and from the fraud management module 60. For example, the information integrator can import alert files and inquiry information from multiple external fraud detection tools, import financial institution internal fraud files including overdrafts and returned items, and import customer account information and transaction history data to the fraud management module 60. The information integrator can also export files or interface action items to an institution's core customer account management systems; export files or interfaces to “hot files” or “hot lists,” which track individuals and/or accounts identified as being involved in fraudulent behavior; export information to risk databases and systems; export information back to the fraud solution functions 58 in order to complete a fraud management loop; export information to data contribution systems; and/or export data to industry standard shared databases. Using the access mechanisms, the information integrator can obtain and integrate alerts received from the fraud solution functions 58 as well as other information related to the alerts, such as customer demographic information and transaction history. The consolidated information can then be used as a single data source that includes relevant fraud-related information from multiple sources and systems. In some embodiments, providing a centralized researching tool, such as the information integrator, can decrease the expense of research, since a separate researching tool associated with each fraud function solution 58 is not needed. A centralized researching tool can also eliminate redundant data acquisition or research, and, therefore, increase researching efficiency.

In order to collect information related to an alert, the information integrator can manage a research workflow environment that defines what and from where information related to an alert should be obtained. The information can be obtained from internal information (i.e., system and data repositories internal to or included in systems of the client managing or executing the integrated fraud management system 50, such as a financial institution). For example, a financial institution can access customer account information (e.g., demographic information, transaction history, etc.) for a customer associated with a received alert. In some embodiments, information can also be obtained from external systems. For example, a financial institution managing the integrated fraud management system 50 can obtain data related to an alert from another financial institution, a loan provider, an insurance provider, a brokerage firm, and/or a credit card company. As described above, the information integrator can also provide one or more tools for exporting data from an alert or an investigation case for a variety of purposes.

After fraud-related data is collected with the information integrator, the fraud management module 60 can provide alert processing and decisioning in order to determine whether an alert merits further investigation or review by a research analyst. In some embodiments, the fraud management module uses a decision engine to determine whether an alert (and any related information) represents potential or confirmed fraudulent behavior. The decision engine can include a business rules engine that applies business rules in order to prioritize and/or categorize alerts into appropriate work queues. In some embodiments, the decision engine can also determine when additional information is needed in order to prioritize and/or categorize an alert. The decision engine can obtain needed additional data using a call-out to an external system and/or process. The decision engine can also provide functionality for immediately processing alerts that can be handled automatically. The decision engine can be configured to provide automated decisioning processing when applicable. For example, the rules governing the decision engine can be configured in order to customize the researching and/or decisioning performed by the decision engine. In some embodiments, decisions determined during the decision analysis step 72 can be translated into automatic actions to be performed by the fraud management module 60 or other components of the integrated fraud management system 50, such as generating correspondence, generating follow-up reminders, performing account dispositions, performing alert or event escalation, creating an investigation case, and/or creating a collection process or plan.

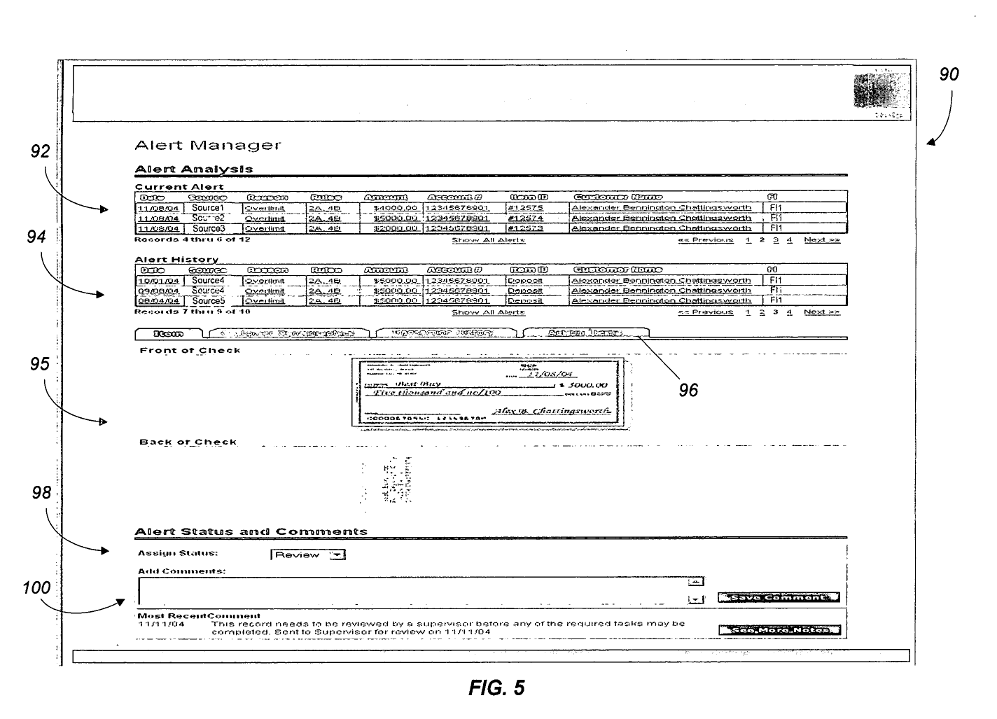

In some embodiments, during the decision analysis step 72, the fraud management module 60 determines whether manual intervention is required. If an alert cannot be automatically decisioned and, therefore, requires the intervention of a research analyst or other authorized personnel, the fraud management module 60 can provide a research and decisioning user interface. The research and decisioning user interface displays alerts (and any related data) obtained from multiple sources to an authorized individual or group of individuals (such as a research analyst). The research analyst can review the alert and can determine what actions should be taken. FIGS. 5-7 illustrate a research and decisioning user interface 90 according to one embodiment of the invention. The research and decisioning user interface 90 can provide a consolidated or “back office” view of alerts and other fraud-related data processed and managed by the fraud management module 60 of the integrated fraud management system 50.

As shown in FIGS. 5-7, the research and decisioning user interface 90 presents alerts combined with other related alert information (e.g., customer demographic information, transaction history; images of documents, such as checks; executed and pending action items; etc.) in order to enable a research analyst to assess and decision the alert. The research and decisioning user interface 90 can also allow a research analyst to request additional data from external system and/or processes that the research analyst may need in order to process an alert.

As also shown in FIGS. 5-7, the research and decisioning user interface 90 displays one or more current alerts 92 and one or more history alerts 94 (if applicable). Each alert can include a date, a source, a reason, a rule, an amount, an account number or identifier, an item identifier, a customer name or identifier, and a system associated with the alert, such as a particular financial institution that manages an account associated with the alert. In some embodiments, the research and decisioning user interface 90 also displays images 95 of items, such as a check, associated with a particular alert. The research and decisioning user interface 90 also allows a research analyst to manually implement action items related to an alert by selecting the action item tab 96. The action items can specify one or more actions to be performed, such as the generation of correspondence, the generation of follow-up reminders, the dispositions of accounts, escalation, the creation of an investigation case, and/or the creating of a collection process or plan. Actions to be taken can be automated (i.e., functionality provided by the integrated fraud management system) and/or can be manual, where a research analyst uses external tools or processes in order to complete an action.

As shown in FIGS. 5-7, in some embodiments, a research analyst can change the status of an alert (e.g., from “REVIEW” to “CLEARED”) using the status field 98. A research analyst can also request or suggest additional actions to be taken in order to process the alert using the research and decisioning user interface 90. Using the research and decisioning user interface 90, a research analyst can document steps performed or needed to be performed in order to process an alert and/or can add, save, and review comments related to an alert. For example, a research analyst can add and review comments associated with a particular alert using a comments field 100 of the research and decisioning user interface 90. It should be understood that the research and decisioning user interface 90 can display automatically managed or processed alerts as well as alerts requiring manual intervention.

In some embodiments, the research and decisioning user interface 90 also provides loss management operations in order to assign research analysts, organized individually or by a work group, to specific work queues containing pending alerts requiring manual intervention. As a research analyst signs on to the integrated fraud management system 50 and views the research and decisioning user interface 90, the research analyst can be automatically informed of and assigned one or more alerts or alert work units from a prioritized work queue. When a research analyst completes processing of an alert or an alert unit, the next item from a prioritized work queue can be automatically assigned and displayed to the research analyst.

As described above, an investigation case can be created for an alert. As shown in FIG. 4, during the case management step 74, cases can be passed to a case management system, such as the Investigations Case Management Solution provided by eFunds Corporation. The case management system can manage investigations pertaining to alerts identified for further review. The case management system can provide a facility to investigate confirmed and/or potential fraudulent cases or non-compliance related cases. In some embodiments, during the investigation of a confirmed and/or potential fraud case or a compliance case, a case investigator can use the case management system to obtain additional data from external systems and/or processes, which may be needed to manage the investigation case. The case management system can also provide one or more types of suspicious active report (“SAR”) generation tools for compliance reporting, recovery documentation, and investigative processes. The case management system can also provide investigative reporting tools in order to assist an investigator and an investigations management process. Additionally, the case management system can provide analytical tools that can be used to mine and search research data accessible by the case management system and/or the integrated fraud management system 50.

In some embodiments, the fraud management module 60 also provides linking functionality. The linking functionality can find relationships between current research items (e.g., alerts, related data, case management data, etc.) and other alerts (i.e., current alerts and past alerts); case management records of known fraud; internal institution systems that include information such as customer information, account history, and customer profitability; and/or external data sources. In some embodiments, the integrated fraud management system 50 can provide an automated linking process that includes an information mover that examines each incoming alert for links or associations with other current or past data processed by the integrated fraud management system 50. The linking process can also list or display available links to an investigator and/or research analyst, and an investigator and/or research analyst can use the displayed links to associate an alert with previous or existing research cases and/or investigative cases. Multiple related items can also be combined into a single case during the linking process.

As shown in FIG. 4, the fraud management process 66 also includes an analytics step 76. The fraud management module 60 can provide tools for analyzing and producing dynamic business information that can be applied in the future as a customized attempt to reduce fraud and fraud-related losses. In some embodiments, the fraud management module 60 provides analytical tools that generate detailed fraud reports. The fraud reports can be categorized by branch, category, and/or region. The fraud management module 60 can also provide flexible online and/or interactive analytical tools that provide in-depth data mining analysis on a broad range of data. The analytical tools can use fraud pattern detection to look for fraud rings and identify specific problem areas within an institution. In addition, the analytical tools can provide recommendations for reducing fraud loss and can measure the impact of improvements and/or changes made to the integrated fraud management system 50.

After the analytics step 76, data uncovered during the analytics step can be applied to the integrated fraud management system 50 during the improvement step 78 in order to attempt to improve fraud prevention and compliance processes performed by the integrated fraud management system 50. Improvements can include applying process improvements and/or screening tools, implementing new training plans, updating policies and/or procedures, and incorporating new tools (internal or external), such as fraud detection tools, in order to address areas experiencing high loss due to fraudulent transaction. Modifying the integrated fraud management system 50 can increase the effectiveness of the system 50, since the system “learns” from historical data.

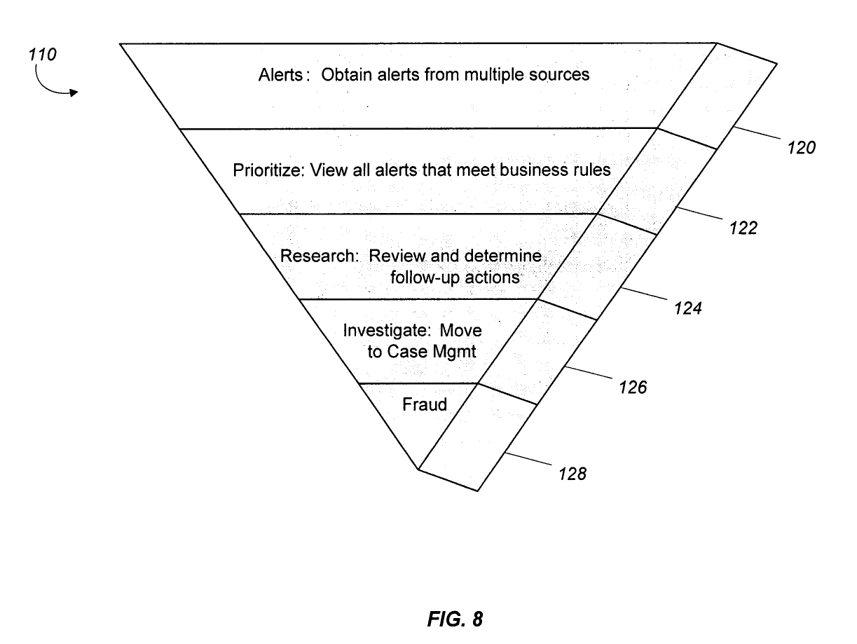

FIG. 8 is a schematic illustration of an alert process 110 performed with an integrated fraud management system in order to detect fraud according to one embodiment of the invention. As described above with respect to FIG. 4, the fraud management process 66 can be used to prioritize and narrow down alerts received from multiple sources and internally process the alerts in order to determine and investigate true fraud cases. As shown in FIG. 8, the first step of the alert process 110 includes obtaining alerts from multiple sources (step 120). The process 110 then prioritizes the obtained alerts by determining alerts that meet business rules (step 122). Alerts can also be prioritized using analytics as described above. After alerts requiring additional data and/or review are identified, the process 110 can research the alerts in order to review and determine what follow-up actions (if any) are needed (step 124). If an alert requires additional review, the alert can be moved to the case management system where an investigative case associated with the alert is established and managed in order to track and/or monitor potentially fraudulent behavior (step 126). Using the investigative cases, true fraudulent behavior can then be detected and terminated (step 128).

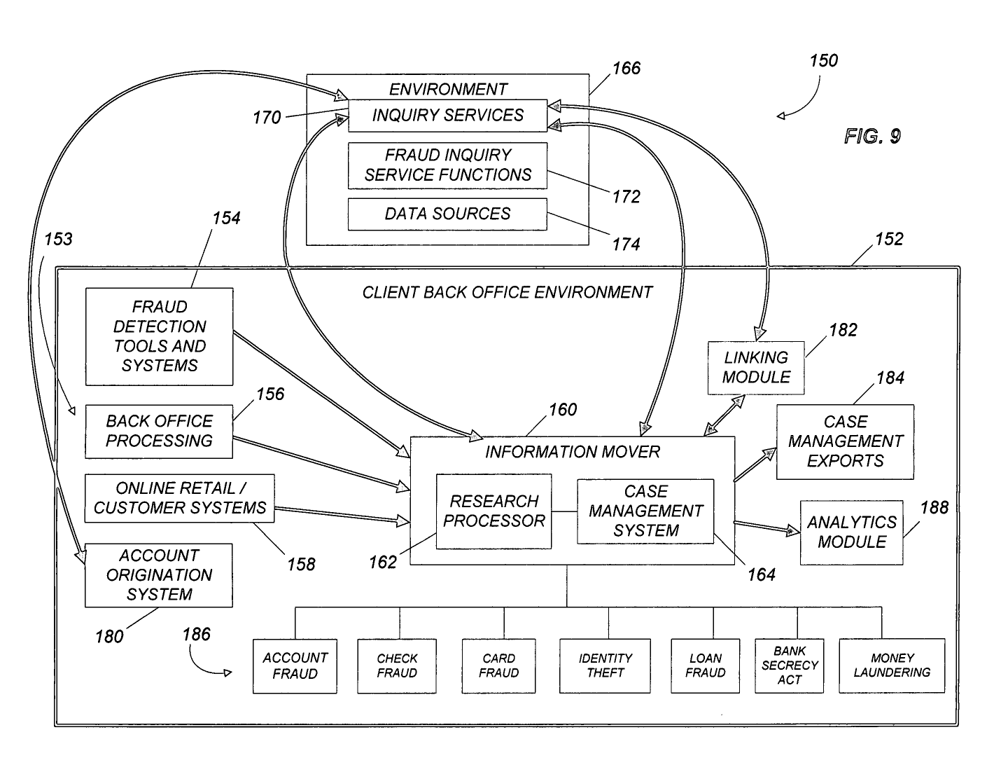

FIG. 9 is another schematic illustration of an integrated fraud management system 150 according to one embodiment of the invention. As shown in FIG. 9, the integrated fraud management system 150 can include a client back office environment 152 that includes one or more alert feeds 153. As shown in FIG. 9, the alert feeds 153 can include one or more fraud detection/management tools or systems 154; back office processing systems 156 that manage overdrafts, account closures, returned items, debit and/or credit card use, loans, and/or anti-money-laundering systems; and online retail/customer systems 158. The alert feeds 153 generate alerts that are transmitted to an information mover 160. The information mover 160 includes a research processor 162 and a case management system 164. The research processor 162 receives the alerts from the alert feeds 153 and determines if additional data and/or verified data is needed in order to process an alert. As described above, additional data related to an alert can be obtained, such as customer account information, demographic information, and/or transaction history information from internal and/or external systems.

If additional data and/or verified data is required to process an alert, the research processor 162 can request data from an environment 166 (e.g., an environment external to the client back office environment 152) that provides inquiry services 170. The environment 166 can also provide fraud inquiry service functions 172 and data sources 174. The inquiry services 170 of the environment 166 receives data requests from the information mover 160 on behalf of the research processor 162 and uses the fraud inquiry service functions 172 and/or the data sources 174 to validate data as requested by the research processor 162 and/or provide additional data related to a customer and/or account associated an alert. The environment 166 (e.g., the inquiry services 170) can forward the requested data back to the information mover 160.

The inquiry services 170 of the environment 166 can also receive data requests and/or verifications directly from systems and applications managed by the client back office environment 152. For example, the client back office environment 152 can include an account origination system 180 that can request account origination decisioning from the environment 166 (i.e., an indication as to whether or not a customer should be allowed to open an account and/or, if a customer is allowed to open an account, what restrictions and/or privileges should be imposed on the account). In some embodiments, the account origination system 180 can be used to manage the opening of a demand deposit account (“DDA”) where a customer is required to deposit money into an account upon opening the account.

The inquiry services 170 of the environment 166 can receive account origination decisioning requests from the account origination system 180, and the environment 166 can use the fraud inquiry service functions 172 and/or the data sources 174 to service the account origination decisioning requests. The inquiry services 170 can return a response to the account origination system 180.

In some embodiments, during the account origination decisioning, the fraud inquiry service functions 172 can generate one or more alerts associated with the attempted account opening, and the inquiry services can forward the alerts to the information mover 160. The inquiry services 170 can also forward the alerts to the account origination system 180, which can then forward the alerts to the information mover 160.

As also shown in FIG. 9, the client back office environment 152 can include a linking module 182 that obtains information from the information mover 160 and the environment 166. As described above with respect to FIG. 4, the linking module 182 can “link” (i.e., associate) alerts and related data with other alerts and/or data being processed by the integrated fraud management system 150. For example, multiple alerts can be generated by multiple fraud detection/management systems 154 related to a single transaction involving a particular account and/or customer, and the linking module 182 can link data provided in the alerts together such that redundant processing is not performed. In addition, the linking module 182 can link multiple alerts associated with multiple transactions involving the same account and/or customer. By linking the alerts together, the integrated fraud management system 150 can process the alerts as a singe entity rather than individually, which otherwise may more easily slip through the integrated fraud management system 150 without being noticed.

After the research processor 162 obtains data related to a particular alert and/or verified data related to a particular alert, the research processor 162 can process the alert in order to determine whether additional review of the alert is required and/or whether the alert indicates true fraud or attempted fraud. In some embodiments, the research processor 162 can include a decision engine that applies business rules in order to prioritize, categorize, and/or automatically process alerts. The research processor 162 can also provide a research and decisioning user interface, as described above with respect to FIGS. 5-7, that allows a research analyst to review alerts as well as related data and to manually prioritize, categorize, and/or process an alert and/or an event.

If the research processor 162 determines or confirms that an alert is associated with true fraudulent behavior, the research processor 162 can interact with the case management system 164 in order to establish and manage an investigation case associated with the identified fraudulent behavior. The case management system 164 can be configured to use the data included in the alert (and related data if applicable) to generate one or more case management exports 184. The case management exports 184 can include alerts, reports, and/or other data that are provided to external fraud management systems and services. For example, the case management system 164 can generate and file SARs, can access general ledger systems in order to book losses generated by the identified fraud, and/or generate or modify “hot lists.”

The case management system 164 can also categorize identified fraud and can route investigation cases to one or more fraud recovery and/or management systems 186 based on the type of fraud. For example, as shown in FIG. 9, the case management system 164 can interact with account fraud management systems, check fraud management systems, card fraud management systems, load fraud management system, identity fraud management systems, bank secrecy act fraud management systems, and money laundering fraud management systems. It should be understood that each fraud management system 186 can be part of the client back office environment 152 or an external environment.

As shown in FIG. 9, the integrated fraud management system 150 can include an analytics module 188. The analytics module 188 can be used to obtain information associated with the integrated fraud management system 150, such as information managed and/or used by the research processor 162, the linking module 180, the case management system 164, etc., and can look for fraud patterns and/or areas with high occurrences of fraud alerts and/or confirmed fraud. In some embodiments, the analytics module 188 can also generate reports and/or recommend processing modifications to be made to the integrated fraud management system 150 in order to attempt to decrease fraud. In addition, the analytics module 188 can automatically implement identified improvements and/or solutions throughout the integrated fraud management system 150.

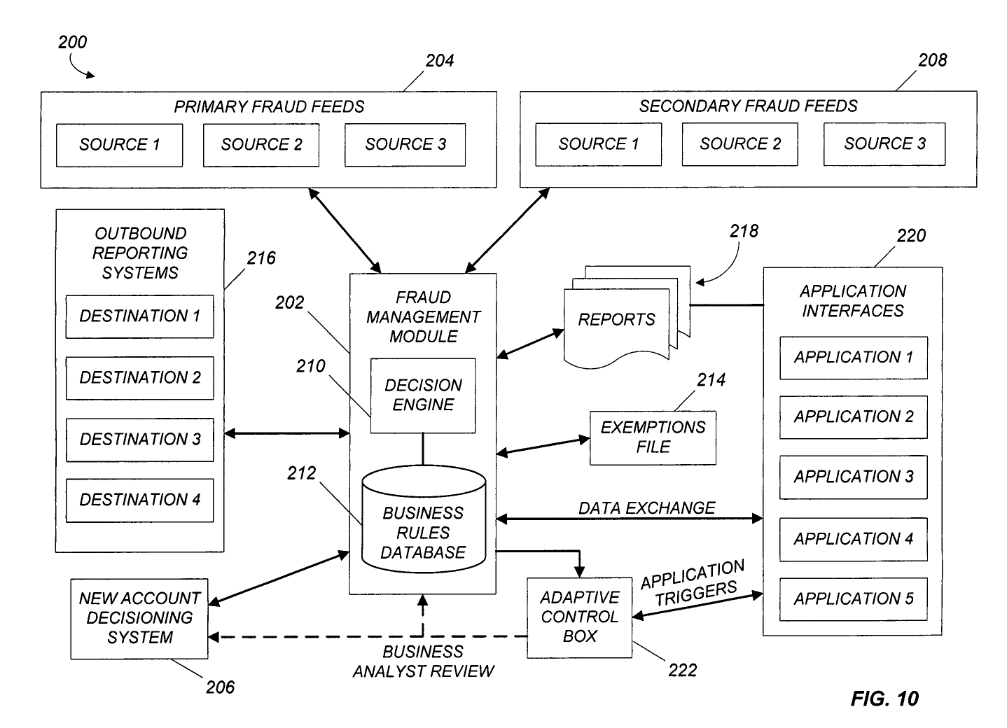

FIG. 10 illustrates still another integrated fraud management system 200 according to one embodiment of the invention. The integrated fraud management system 200 includes a fraud management module 202 that is fed alerts from one or more “primary fraud” feeds 204. The “primary fraud” feeds 204 provide transaction processing and, therefore, generate transaction alerts. The fraud management module 202 also obtains alerts from a new account decisioning system 206. As described above with respect to FIG. 9, the new account decisioning system 206 can determine whether a customer should be allowed to open an account, such as a DDA, and/or whether a customer should be allowed to receive particular privileges associated with an account.

As shown in FIG. 10, the fraud management module 202 is also fed data from one or more “secondary fraud” feeds 208, which provide data related to an alert generated by one of the “primary fraud” feeds 204 and/or the new account decisioning system 206.

As described above, the fraud management module 202 consolidates the alerts and other related data from the “primary fraud” feeds 204, the “secondary fraud” feeds 208, and the new account decisioning system 206. In some embodiments, the fraud management module 202 uses a decision engine 210 to prioritize, categorize, and automatically process an alert. In some embodiments, the decision engine 210 accesses a database 212 storing business rules, and the decision engine 210 applies the business rules in order to prioritize, categorize, and automatically process an alert. The fraud management module 202 can also provide a research and decisioning user interface that allows a research analyst to review alerts and manually prioritize, categorize, and process an alert.

In some embodiments, the fraud management module 202 can access an exemptions file or system 214 that defines override conditions or rules. The override condition or rules can define particular customers and/or accounts that are exempt from alert processing. For example, some large companies and/or companies whose transactions are important and/or trusted by the client managing the fraud management module may be exempt from alert processing.

After prioritizing, categorizing, and/or automatically processing an alert, the fraud management module 202 can provide alert processing reporting files and/or logging to one more or more outbound reporting systems 216. The outbound reporting systems 216 can include data acquisition systems established by the American Bankers Association (“ABA”) and/or the Bankers Information Technology subgroup (“BITS”) that collect and share fraud-related data in the financial industry. The fraud management module 202 and/or the outbound reporting systems 216 can also generate reports that provide logging and/or operational statistics of the integrated fraud management system 200.

In some embodiments, the fraud management module 202 is configured to exchange data (e.g., reports 218) with application interfaces 220 in order to share fraud-related data. In some embodiments, the application interfaces 220 can include institution specific applications, such as a deposit system, a collections system, etc., which can exchange particular data with the integrated fraud management system 200.

The application interfaces 220 can also generate application triggers that are provided to an adaptive control box 222. The application interfaces 220 can generate application triggers when a particular application requires new data from the fraud management module 202 and/or can provide new data to the fraud management module 202. The application interfaces 220 can also generate application triggers when a particular application senses a need to modify operation of the integrated fraud management system 200. For example, if a deposit application or system is backlogged and is no longer processing requests in real-time, the deposit application can inform the adaptive control box 222 of the condition so that the integrated fraud management system 200 can modify its operation accordingly.

The adaptive control box 222 can also receive operational data from the fraud management module 202 and can use the data to learn and identify fraud patterns observed by the fraud management module 202 (or other components of the integrated fraud system 200). In some embodiments, the adaptive control box 222 can report and/or display observations or trends in alert processing and can recommend modifications to make to the integrated fraud management system 200 in order to address negative observations. A business analyst may review the observations and recommendations reported by the adaptive control box 222, and the business analyst may manually implement the recommended changes to the fraud management module 202, the new account decisioning system 206, and/or other components of the integrated fraud management system 200. In some embodiments, the adaptive control box 222 (either automatically or under the instruction of a business analyst) can automatically implement recommended modifications.

Although embodiments of the integrated fraud management system are described above with reference to a financial institution and an account origination application (e.g., a DDA), it should be understood that embodiments of the integrated fraud management system can be applied to other systems in various markets, such as retail systems, card systems (i.e., electronic purses (“EP”), credit card, online payment processing and/or fraud prevention, etc.), telecommunications systems, insurance systems, and other systems of national and international markets. For example, an embodiment of the integrated fraud management system can be applied to a retail market in order to connect retailers with shared investigation tool for detecting check fraud through SCAN. In other embodiments, which may be implemented either alone or as an enhancement to existing systems, the integrated fraud management system can be used to ensure Patriot Act compliance or to detect fraudulent transactions used to fund terrorist organizations.

Various features and advantageous of the invention are set forth in the following claims.

1. A system for managing a plurality of alerts, each of the plurality of alerts indicating potentially fraudulent activity, the system comprising:
a fraud management module operative to receive a plurality of alerts from a plurality of fraud detection tools and to process the plurality of alerts.

2. The system of claim 1 further comprising a plurality of fraud detection tools, each of the plurality of fraud detection tools operative to receive an inquiry from at least one inquiry source, to process the inquiry, and to generate an alert if the inquiry indicates potentially fraudulent activity.

3. The system of claim 2 wherein the plurality of fraud detection tools includes at least two fraud detection tools operative to detect potentially fraudulent activity in at least two different markets.

4. The system of claim 2 wherein at least one of the plurality of fraud detection tools is operative to process an inquiry by obtaining additional data from at least one data source.

5. The system of claim 2 wherein the at least one inquiry source includes an account origination system.

6. The system of claim 1 wherein the fraud management module is further operative to obtain additional data from at least one data source.

7. The system of claim 6 further comprising a linking module operative to link at least one of the plurality of alerts to the additional data.

8. The system of claim 1 further comprising a linking module operative to link a first alert included in the plurality of alerts to a second alert included in the plurality of alerts.

9. The system of claim 1 wherein the fraud management module is further operative to process the plurality of alerts by categorizing the plurality of alerts.

10. The system of claim 1 wherein the fraud management module is further operative to process the plurality of alert by prioritizing the plurality of alerts.

11. The system of claim 1 wherein the fraud management module is further operative to process the plurality of alerts by automatically performing at least one action.

12. The system of claim 11 wherein the at least one action includes clearing an alert.

13. The system of claim 11 wherein the at least one action includes creating an investigative case related to an alert.

14. The system of claim 13 wherein the fraud management module is further operative to provide the investigative case to at least one fraud management system.

15. The system of claim 1 wherein the fraud management module is further operative to process the plurality of alerts by displaying at least one of the plurality of alerts to an analyst for manual processing.

16. The system of claim 1 wherein the fraud management module is further operative to process the plurality of alerts based on a plurality of rules.

17. The system of claim 16 further comprising an analytical module operative to identify at least one modification to be made to the plurality of rules.

18. The system of claim 17 wherein the analytical module is further operative to automatically modify the plurality of rules based on the at least one modification.

19. The system of claim 1 wherein the fraud management module is further operative to report results of processing the plurality of alerts to at least one reporting system.

20. A method of managing a plurality of alerts, each of the plurality of alerts indicating potentially fraudulent activity, the method comprising:
receiving a plurality of alerts from a plurality of fraud detection tools; and
processing the plurality of alerts.

21. The method of claim 20 further comprising providing a plurality of fraud detection tools, each of the fraud detection tools operative to receive an inquiry from at least one inquiry source, to process the inquiry, and to generate an alert if the inquiry indicates potentially fraudulent activity.

22. The method of claim 21 wherein providing a plurality of fraud detection tools includes providing a plurality of fraud detection tools including at least two fraud detection tools operative to detect potentially fraudulent activity in at least two different markets.

23. The method of claim 21 wherein providing a plurality of fraud detection tools includes providing a plurality of fraud detection tools including at least one fraud detection tool operative to process an inquiry by obtaining additional data related to the inquiry from at least one data source.

24. The method of claim 21 wherein providing a plurality of fraud detection tools includes providing a plurality of fraud detection tools including at least one fraud detection tool operative to receive an inquiry from an account origination system.

25. The method of claim 20 further comprising obtaining additional data from at least one data source.

26. The method of claim 25 further comprising linking at least one of the plurality of alerts to the additional data.

27. The method of claim 20 further comprising linking a first alert included in the plurality of alerts to a second alert included in the plurality of alerts.

28. The method of claim 20 wherein processing the plurality of alerts includes categorizing the plurality of alerts.

29. The method of claim 20 wherein processing the plurality of alerts includes prioritizing the plurality of alerts.

30. The method of claim 20 wherein processing the plurality of alerts includes automatically performing at least one action.

31. The method of claim 30 wherein automatically performing at least one action includes clearing an alert.

32. The method of claim 30 wherein automatically performing at least one action includes creating an investigative case related to an alert.

33. The method of claim 32 further comprising providing the investigative case to at least one fraud management system.

34. The method of claim 20 wherein processing the plurality of alerts includes displaying at least one of the plurality of alerts to an analyst for manual processing.

35. The method of claim 20 wherein processing the plurality of alerts includes processing the plurality of alerts based on a plurality of rules.

36. The method of claim 35 further comprising identifying at least one modification to be made to the plurality of rules.

37. The method of claim 36 further comprising automatically modifying the plurality of rules based on the at least one modification.

38. The method of claim 20 further comprising reporting results of processing the plurality of alerts to at least one reporting system.

39. A method of managing a plurality of alerts, each of the plurality of alerts indicating potentially fraudulent activity, the method comprising:
receiving a plurality of alerts from a plurality of fraud detection tools; and
displaying at least one of the plurality of alerts to an analyst.

40. The method of claim 39 further comprising categorizing the plurality of alerts.

41. The method of claim 39 further comprising prioritizing the plurality of alerts.

42. The method of claim 39 further comprising assigning at least one of the plurality of alerts to at least one analyst.

43. The method of claim 39 further comprising performing at least one action to be performed related to at least one of the plurality of alerts.

44. The method of claim 43 wherein performing at least one action to be performed related to at least one of the plurality of alerts includes clearing at least one of the plurality of alerts.

45. The method of claim 43 wherein performing at least one action to be performed related to at least one of the plurality of alerts includes generating an investigative case related to at least one of the plurality of alerts.

46. The method of claim 39 further comprising entering notes related to at least one of the plurality of alerts.
